(19) United States
(12) Patent Application Publication
(10) Pub. No.: US 2025/0231351 A1
(43) Pub. Date: Jul. 17, 2025

(54) DUST CAP FOR FERRULE AND OPTICAL CONNECTOR

(71) Applicant: HAKUSAN INC., Ishikawa (JP)

(72) Inventors: Moriaki KOBAYASHI, Ishikawa (JP); Shohei UENO, Ishikawa (JP)

(21) Appl. No.: 18/703,209

(22) PCT Filed: Nov. 8, 2022
(86) PCT No.: PCT/JP2022/041488

§ 371 Date: Apr. 19, 2024

(30) Foreign Application Priority Data
Nov. 12, 2021 (JP) 2021-184524

(51) Int. Cl. G02B 6/38

(52) U.S. Cl. CPC G02B 6/3849

(57) ABSTRACT

[Problem] An object of the present invention is to provide a dust cap for a ferrule including a optical multi-fiber ribbon and which are capable of improving a dust-proofing effect, and an optical connector.

[Solution] A dust cap (100) for a ferrule according to the present invention is a dust cap for a ferrule for protecting a tip portion of the ferrule, the dust cap (100) comprising a cap section (200) holding the tip portion (910) of the ferrule (900) and forming a closed space (AR), and a guide rail section (300) guiding the ferrule (900) to the cap section (200), wherein the guide rail section (300) has a shape that guides the tip portion (910) of the ferrule (900) from a direction different from a direction in which the ferrule (900) is guided to the cap section (200).

### TECHNICAL FIELD

The present invention relates to a dust cap for a ferrule and to an optical connector.

### BACKGROUND ART

In optical communication, an optical connector is used to mechanically connect optical fibers.

In particular, an MT connector (mechanically transferable connector) developed for optical network devices is a reliable multi-fiber optical connector in wide practical use in optical communication networks and the like. The MT connector detachably connects a pair of optical connectors using a guide pin and a clip and is used to connect, for example, optical fiber ribbons, optical fiber cords, and the like made up of 2 to 12 fibers. In addition to the MT connector described above, a connector configured as an MPO connector in which an optical ferrule is placed inside a housing and to which a guide pin, a latch mechanism, and the like are mounted is also known.

For example, Patent Literature 1 (Japanese Patent Laid-Open No. 2013-88464) discloses a protective cap to which, with respect to an optical connector including a plurality of ferrules, a portion that collectively protects tips of the respective ferrules can be mounted.

The protective cap described in Patent Literature 1 is a protective cap to be mounted to an optical connector including a plurality of ferrules lined up in parallel to each other and a housing portion which encloses the ferrules in such a manner that a space is formed around each ferrule, the protective cap including: a lid portion which opposes tips of the ferrules and which is positioned at a tip of the housing portion; a cylindrical outer cap portion which is mounted to the housing portion in a state of covering an outside of the housing portion and which is provided so as to extend to the lid portion; and a plurality of cylindrical inner cap portions, each of which encloses the tip of each ferrule in a state of being inserted into each space, and which are provided so as to extend to the lip portion in a state of being arranged inside the outer cap portion.

Patent Literature 2 (Japanese Patent Laid-Open No. 2018-60040) discloses a protective cap for an optical connector plug which is capable of preventing the protective cap from being inadvertently removed during use of a plug main body, during transportation, and the like and which secures and maintains a state of preventing penetration of dust.

The protective cap for an optical connector plug described in Patent Literature 2 is a protective cap for an optical connector plug which covers a ferrule tip portion of a plug main body including a ferrule mounted to a tip of an optical fiber ribbon, a sleeve-like spring bush which houses the ferrule in its tip, a housing mounted to an outer circumference of the spring bush, a cylindrical coupling which sheathes the housing and which is provided so as to be slidable in a movable range secured in an axial direction of the spring bush, a spring which is housed inside the spring bush and which elastically biases the ferrule toward a front of an optical connector, a spring which is housed in a depression between the coupling and the housing and which elastically biases the coupling toward a front of the housing, and a boot mounted to a rear end portion opposite to a front end portion of the spring bush where the ferrule is provided, wherein the protective cap is constituted of a cap main body having a front end portion formed on a closed portion with a substantially pyramid shape and a rear end side formed in a substantially square cylindrical shape by left and right side plates and upper and lower side plates in such a manner that the ferrule of the plug main body is housed from a rear end opening portion of the cap main body, elastic side plates are formed so as to oppose each other in each of upper and lower regions of the left and right side plates or each of left and right regions of the upper and lower side plates of the cap main body by providing a pair of slits from an opening end of the cap main body toward an inner closed portion, a lock mechanism which projects from the rear end opening portion of the cap main body and which is capable of engaging with and disengaging from the spring bush of the plug main body is formed at tips of the elastic side plates, and a cover portion with a substantially square cylindrical shape is formed inside the closed portion of the cap main body so that a ferrule end surface of the plug main body is locked and held in a contactless state when the cap main body covers the plug main body and the lock mechanism is locked by the spring bush.

Patent Literature 3 (Japanese Patent Laid-Open No. 2020-109426) discloses a protective cap capable of preventing contamination of an optically-connected terminal even if dust is present on a wall surface or the like of the protective cap.

The protective cap described in Patent Literature 3 is a protective cap capable of protecting an optically-connected terminal incorporated into an optical fiber terminal portion and includes: a cylindrical portion with one end portion into which the optically-connected terminal can be inserted and fitted; a cap portion constituted of a bottom portion provided at another end portion of the cylindrical portion; and an adhesive portion which is provided inside the cap portion and which is arranged at a position that enables, when inserted and fitted into inside of the cap portion via the optically-connected terminal, a tip of the optically-connected terminal that is inserted and fitted to abut the adhesive portion.

Patent Literature 4 (Japanese Patent Laid-Open No. 2012-37624) discloses an optical connector and an optical connector assembly tool which improve reliability and assembly work efficiency.

The optical connector described in Patent Literature 4 is an optical connector including: a ferrule which includes a hole into which a glass portion of an optical fiber obtained by removing a coating of the optical fiber is inserted along a central axis in a long-axis direction; a flange which grasps the ferrule and which includes a hole portion where a coated portion of an optical fiber inserted into the ferrule deflects and an optical fiber deflection regulating portion; and an optical fiber grasping portion which elastically holds the optical fiber, wherein the hole portion has an inner diameter large enough to enable the optical fiber to deflect, the optical fiber deflection regulating portion is a column which is positioned in a region closer to the ferrule than a center position of the hole portion, which has a long axis on the central axis in the long-axis direction of the ferrule, and which as a hole diameter that is slightly larger than an outer diameter of the coated portion of the optical fiber, and the optical fiber grasping portion elastically holds the coated portion of the optical fiber in a state where a tip of the optical fiber protrudes from an end surface of the ferrule and presses and connects end surfaces of optical fibers to each other by an elastic restoring force generated by a deflection of the optical fiber.

Patent Literature 5 (Japanese Patent Laid-Open No. 2006-119163) discloses an optical connector protective cap capable of reliably and ready performing dust-proofing and protection of an optical connector by taking advantages of a fitting type of which coverage includes a housing portion of the optical connector and an insertion type which only covers a ferrule portion.

The optical connector described in Patent Literature 5 is an optical connector protective cap which is attachably/detachably mounted to an optical connector including a ferrule having an optically-connected end surface in a top portion of the ferrule and a housing constructed by providing a gap portion between the ferrule and the housing and which protects the optical connector by closing the optically-connected end surface, the optical connector protective cap including: an outer wall which extends along an outer face of the housing; a tubular wall which stores and protects the optically-connected end surface; and a dustproof wall which extends to the gap portion.

Patent Literature 6 (Japanese Patent Laid-Open No. 1997-297244) discloses a ferrule protective cap which prevents a butt end surface of a ferrule being susceptible to contamination due to adherence of dust or oil when exposed and damage due to collision with obstacles from affecting transmission reliability of an optical signal during butt connection.

The ferrule protective cap described in Patent Literature 6 is a ferrule protective cap (1) for protecting a ferrule constituting an optical connector which performs a butt connection of optical fibers by terminating tips of the optical fibers and causing the tips to butt against each other, the ferrule protective cap including: a cap main body which covers a butt end surface of the ferrule by being mounted to the ferrule; and mounting means which detachably mounts the cap main body to a support member.

Patent Literature 7 (Japanese Patent Laid-Open No. 2020-148898) discloses a cap for a ferrule which can be prevented from becoming inadvertently detached from the ferrule and which can be detached from the ferrule by a simple operation without affecting a connection state of fused connecting portions of optical fibers in a state of being mounted to the ferrule.

The cap for a ferrule described in Patent Literature 7 includes: a cap main body with a bottomed tubular shape capable of housing a ferrule; and open operation pieces which protrude rearward from a rear wall of the cap main body that closes a rear end portion opposite to a front end opening portion of the cap main body, wherein the cap main body includes the rear wall and a tubular wall portion with a half-split shape having a pair of tubular wall half bodies that extend forward from an outer circumferential portion of the rear wall, a depression for engagement into which a flange portion of the ferrule can be inserted is formed at positions that correspond to each other through inner regions of the tubular wall portion with the pair of tubular wall half bodies, and the cap for a ferrule is configured to enable the rear wall to elastically curve and deform and to enable a distance between front ends of the pair of tubular wall half bodies to increase by causing the open operation pieces provided so as to respectively corresponding to the pair of tubular wall half bodies to approach each other.

### CITATION LIST

### Patent Literature

Patent Literature 1: Japanese Patent Laid-Open No. 2013-88464
Patent Literature 2: Japanese Patent Laid-Open No. 2018-60040
Patent Literature 3: Japanese Patent Laid-Open No. 2020-109426
Patent Literature 4: Japanese Patent Laid-Open No. 2012-37624
Patent Literature 5: Japanese Patent Laid-Open No. 2006-119163
Patent Literature 6: Japanese Patent Laid-Open No. 1997-297244
Patent Literature 7: Japanese Patent Laid-Open No. 2020-148898

### SUMMARY OF INVENTION

### Technical Problem

It is disclosed in Patent Literature 1 that the protective cap described in Patent Literature 1 protects a tip portion of an optical connector. However, a problem arises in that, when inserting the protective cap, there is a risk that the tip portion of the optical connector may come into contact with end surfaces of the inner cap portions.

In addition, the protective cap for an optical connector plug described in Patent Literature 2 is provided with the lock mechanism which is capable of engaging with and disengaging from the spring bush of the plug main body and cannot protect a ferrule main body which is not provided with a spring bush.

Furthermore, although the protective cap described in Patent Literature 3, realizes protection with respect to an SC connector being a single optical fiber being an optically-connected terminal, the protective cap cannot protect an MT ferrule.

While it is disclosed in Patent Literature 4 that an optical connector cap is to be mounted to the optical connector described in Patent Literature 4, a structure is adopted in which a tip of an optical fiber butts against a wall of the optical connector cap, which becomes a problem when dust is adhered to the wall.

In addition, in the optical connector protective cap described in Patent Literature 5, since a portion of one optical fiber protrudes from the ferrule like an SC connector, there is a possibility that a tip of one optical fiber and the dustproof wall of the optical connector protective cap may come into contact with each other when mounting the optical connector protective cap, making it difficult to realize total dustproofing. Furthermore, in the case of a optical multi-fiber ribbon, a problem arises in that the optical multi-fiber ribbon cannot be accommodated.

As described above, since single-fiber cylindrical ferrules such as an SC connector and an LC connector generally have full zirconia characteristics, dust caps are often configured to cover a ferrule tip.

In addition, since the protective cap for a ferrule described in Patent Literature 6 is structured to be inserted in one direction, a tip of the ferrule sometimes comes into contact with an insertion port of the cap main body 5, which is not preferable.

Furthermore, the cap for a ferrule described in Patent Literature 7 has a sandwiching structure. Therefore, the cap for a ferrule cannot be repetitively used. In other words, a problem is that the structure does not allow continuous use. Another problem is that, since open operation pieces must be provided, downsizing is difficult.

An object of the present invention is to provide a dust cap for a ferrule including a optical multi-fiber ribbon and which are capable of improving a dust-proofing effect, and an optical connector.

Another object of the present invention is to provide a dust cap for a ferrule including a optical multi-fiber ribbon which can be continuously and repetitively used and which are capable of improving a dust-proofing effect, and an optical connector.

### Solution to Problem

(1)

A dust cap for a ferrule according to one aspect is a dust cap for a ferrule for protecting a tip portion of the ferrule, the dust cap including a cap section holding a tip portion of a ferrule and forming a closed space and a guide rail section guiding the ferrule to the cap section, and the guide rail section may have a shape that guides the tip portion of the ferrule from a direction different from a direction in which the ferrule is guided to the cap section.

The dust cap for a ferrule according to the present invention includes the guide rail section and a cap section. In this case, since the guide rail section can guide the tip portion of the ferrule from a direction different from the direction in which the ferrule is guided to the cap section, contact with the tip portion of the ferrule can be prevented. In addition, the tip portion of the ferrule can be housed in the cap section without coming into contact with a part of the dust cap for a ferrule. As a result, adherence of dust or staining that adheres to the tip portion of the ferrule can be readily prevented, end surfaces during storage and transportation can be protected and, furthermore, since staining of the optical fiber portion of the ferrule end surface can be prevented, loss during connection of the optical connector can be suppressed. Furthermore, since the structure is simple, a size of the entire ferrule attached with the dust cap for a ferrule can be reduced.

(2)

The dust cap for a ferrule according to a second invention is a dust cap for a ferrule according to the one aspect, wherein the guide rail section includes a blocking section which blocks guidance of a flange portion of the ferrule to the cap section.

In this case, since the blocking section which blocks guidance of the flange portion provided in the ferrule to the cap section, the ferrule can be reliably blocked from being pushed into the cap section. In other words, the ferrule can be prevented from being pushed in more than expected.

(3)

The dust cap for a ferrule according to a third invention is the dust cap for a ferrule according to the second invention, wherein the closed space of the cap section may form a space with a rectangular parallelepiped shape in a state where the flange portion is being blocked by the blocking section.

In this case, since the closed space is formed between the tip portion of the ferrule and the dust cap for a ferrule when the flange portion is blocked by the blocking section, dust or staining can be prevented from adhering to the tip portion of the ferrule. In addition, even when a spacer, a lens, or a fixing pin is attached to the tip portion of the ferrule, since the space with a rectangular parallelepiped shape is formed, adherence of dust or staining can be readily prevented.

Preferably, the rectangular parallelepiped space measures 1 mm or more along a direction in which the ferrule is guided.

(4)

The dust cap for a ferrule according to a fourth invention is the dust cap for a ferrule according to the one aspect to the third invention, wherein the guide rail section includes a bottom surface and a pair of ribs which correspond to the tip portion of the ferrule and which block the flange portion of the ferrule, and the cap section forms the closed space with a bottom surface provided so as to be communicated from the bottom surface, walls provided so as to be communicated from the pair of ribs, a top surface which opposes the bottom surface and which is capable of housing the ferrule, and a closing wall which closes the direction of guidance.

In this case, the guide rail section includes the bottom surface and the pair of ribs which correspond to the tip portion of the ferrule. Therefore, the tip portion of the ferrule can be held with the bottom surface and the pair of ribs.

In this case, the tip portion of the ferrule can be prevented from coming into contact with something.

In addition, the ferrule is inserted in a direction of guidance from the guide rail section toward a side of the cap section. Even in this case, since the pair of ribs are communicated and the bottom surface is also communicated, the tip portion of the ferrule can be readily inserted into the cap section.

As a result, even when the ferrule is guided, the tip portion of the ferrule can be prevented from coming into contact with something. Furthermore, prevention of adherence of dust or staining to the tip portion of the ferrule can be realized.

(5)

An optical connector according to another aspect is an optical connector in which the dust cap for a ferrule according to any one of the one aspect to the fourth invention is mounted to a ferrule.

The dust cap for a ferrule according to the present invention includes the guide rail section and a cap section. In this case, since the guide rail section can guide the tip portion of the ferrule from a direction different from the direction in which the ferrule is guided to the cap section, contact with the tip portion of the ferrule can be prevented. In addition, the tip portion of the ferrule can be housed in the cap section without coming into contact with a part of the dust cap for a ferrule. As a result, adherence of dust or staining that adheres to the tip portion of the ferrule can be readily prevented, end surfaces during storage and transportation can be protected and, furthermore, since staining of the optical fiber portion of the ferrule end surface can be prevented, loss during connection of the optical connector can be suppressed. Therefore, an optical connector capable of holding a communication rate can be obtained.

### BRIEF DESCRIPTION OF DRAWINGS

FIG. 1 is a schematic view showing an example of a dust cap for a ferrule according to the present embodiment.

FIG. 2 is a schematic sectional view showing an example of mounting a ferrule to the dust cap for a ferrule.

FIG. 3 is a schematic perspective view showing an example of mounting a ferrule to the dust cap for a ferrule.

FIG. 4 is a schematic perspective view showing an example of mounting a ferrule to the dust cap for a ferrule.

FIG. 5 is a schematic perspective view showing an example of mounting a ferrule to the dust cap for a ferrule.

FIG. 6 shows an example of a result of dust or staining using a conventional dust cap for a ferrule and the dust cap for a ferrule according to the present invention.

FIG. 7 is a schematic perspective view showing an example of a conventional dust cap for a ferrule.

### DESCRIPTION OF EMBODIMENT

Hereinafter, an embodiment of the present invention will be described with reference to the drawings. In the following description, same components are assigned the same reference signs. In addition, names and functions of such components are also the same. Therefore, detailed descriptions of such components will not be repeated.

### EMBODIMENT

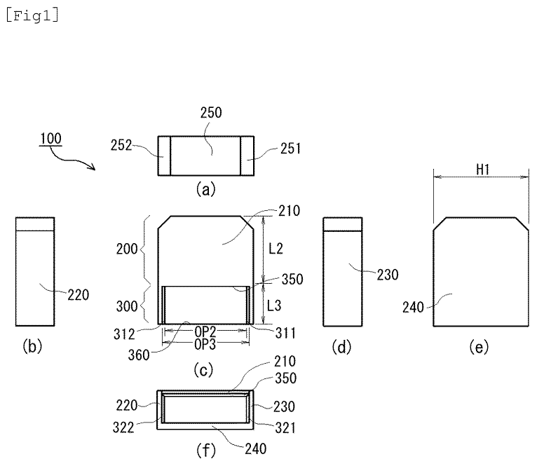

FIG. 1 is a schematic view showing an example of a dust cap 100 for a ferrule according to the present embodiment. FIG. 1(a) is a plan view of the dust cap 100 for a ferrule, FIG. 1(b) is a left-side wall view of the dust cap 100 for a ferrule, FIG. 1(c) is a front view of the dust cap 100 for a ferrule, FIG. 1(d) is a right-side wall view of the dust cap 100 for a ferrule, FIG. 1(e) is a rear view of the dust cap 100 for a ferrule, and FIG. 1(f) is a bottom view of the dust cap 100 for a ferrule.

### (Dust Cap 100 for Ferrule)

As shown in FIG. 1, while the dust cap 100 for a ferrule according to the present embodiment is formed of one member, the dust cap 100 for a ferrule will be described as being made up of a cap section 200 and a guide rail section 300.

In addition, the dust cap 100 for a ferrule is preferably formed of an elastomer. In particular, since a material that withstands cleaning or drying by air, cleaning with a solvent, or ultrasonic cleaning or ease of cleaning is required, the dust cap 100 for a ferrule is preferably formed of a soft material or any similar material.

### (Cap Section 200)

An internal space of the cap section 200 is formed by a top surface 210, a left-side wall 220, a right-side wall 230, a bottom surface 240, and a closing wall 250.

In addition, a C surface 251 and a C surface 252 are formed at corners in an outer periphery of the cap section 200. While the C surface 251 and the C surface 252 are provided in the present embodiment, this configuration is not restrictive and a C surface may only be provided on one side, sizes of the C surface 251 and the C surface 252 may be respectively changed, or only the surface on one side may be changed to an R shape. As a result, a front surface and a rear surface can be determined when using an automatic manufacturing machine or the like.

As shown in FIG. 1(c), the top surface 210 of the cap section 200 has a shape created by forming the C surface 251 and the C surface 252 at two corners of a rectangular shape and, as shown in FIG. 1(e), the bottom surface 240 also has a shape created by forming the C surface 251 and the C surface 252 at two corners of a rectangular shape. The top surface 210 and the bottom surface 240 are respectively parallelly provided so as to oppose each other.

The left-side wall 220 and the right-side wall 230 are provided between the top surface 210 and the bottom surface 240. In the present embodiment, the left-side wall 220 and the right-side wall 230 are provided so as to be erected from the bottom surface 240.

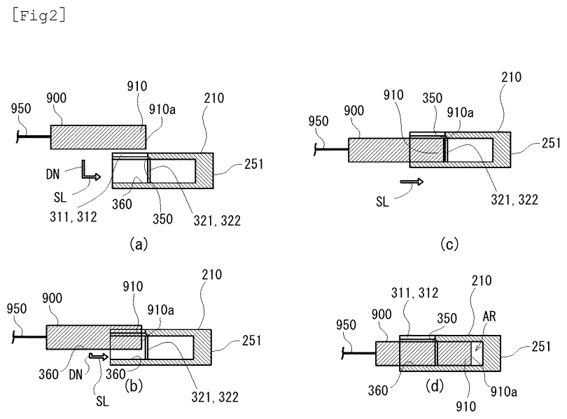

Finally, the closing wall 250 is provided by perpendicularly connecting to ends of the top surface 210, the bottom surface 240, the left-side wall 220, and the right-side wall 230. As a result, a closed space AR (refer to FIG. 2(d)) of the cap section 200 is formed.

### (Guide Rail Section 300)

As shown in FIG. 1(c), the guide rail section 300 is mainly made up of the bottom surface 240, the left-side wall 220, and the right-side wall 230.

In addition, as shown in FIG. 1(c), in the guide rail section 300, the left-side wall 220 is provided with a C surface 312 and the right-side wall 230 is provided with a C surface 311.

Furthermore, as shown in FIG. 1(f), in the guide rail section 300, the left-side wall 220 is provided with a C surface 322 and the right-side wall 230 is provided with a C surface 321. Moreover, as shown in FIG. 1(f), the top surface 210 is provided with a C surface 350.

While the C surface 311, the C surface 312, the C surface 321, the C surface 322, and the C surface 350 are provided in the present embodiment, this configuration is not restrictive and a size or sizes of any one or a plurality of C surfaces may be respectively changed or any one or a plurality of C surfaces may be changed to an R shape.

In the present embodiment, width H1=7.45 mm, width OP2=6.45 mm, and width OP3=6.85 mm.

In other words, a width of a ferrule 900 (refer to FIG. 2) to be inserted into the dust cap 100 for a ferrule is 6.35 mm to around 6.40 mm.

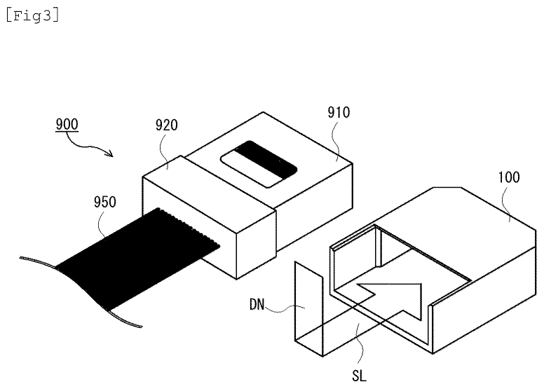

Next, FIG. 2 is a schematic sectional view showing an example of mounting the ferrule 900 to the dust cap 100 for a ferrule, and FIGS. 3 to 5 are schematic perspective views showing the example of mounting the ferrule 900 to the dust cap 100 for a ferrule.

As shown in FIGS. 2(a) and 3, the ferrule 900 is inserted downward from obliquely above (direction of an arrow DN in FIG. 3) into the dust cap 100 for a ferrule according to the present embodiment. In this case, an end surface 910a of a tip portion 910 of the ferrule 900 can be prevented from coming into contact with the dust cap 100 for a ferrule.

Next, as shown in FIG. 2(b), the ferrule 900 is inserted into the guide rail section 300 of the dust cap 100 for a ferrule. In this case, the ferrule 900 can be readily inserted due to the C surface 311 and the C surface 312 of the guide rail section 300 of the dust cap 100 for a ferrule. In addition, the end surface 910a of the ferrule 900 does not come into contact with an end of the bottom surface 240.

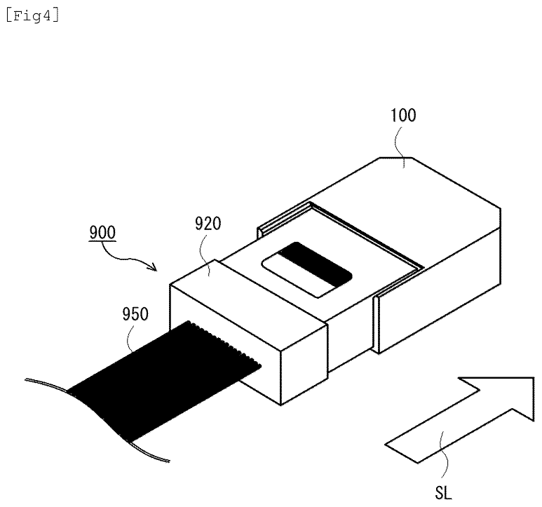

Next, as shown in FIGS. 2(c) and 4, a bottom portion of the ferrule 900 is brought into contact with a surface 360 of the bottom surface 240 of the dust cap 100 for a ferrule. In this case, the ferrule 900 can be readily arranged in the guide rail section 300 of the dust cap 100 for a ferrule.

Next, as shown in FIGS. 2(c) and 4, the ferrule 900 is inserted into the cap section 200 in a direction of an arrow SL in a state where the ferrule 900 is in contact with the surface 360.

In this case, the ferrule 900 can be smoothly inserted due to the C surface 350 of the top surface 210, the C surface 321 of the right-side wall 230, and the C surface 322 of the left-side wall 220 of the dust cap 100 for a ferrule. In addition, an area over which the member of the dust cap 100 for a ferrule comes into contact with the end surface 910a of the ferrule 900 can be minimized.

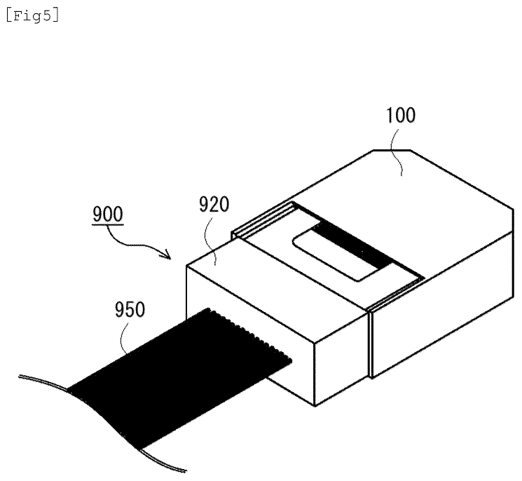

Finally, as shown in FIGS. 2(d) and 5, when the flange portion 920 of the ferrule 900 comes into contact with the end surface of the bottom surface 240, the end surface of the right-side wall 230, and the end surface of the left-side wall 220, a movement of the ferrule 900 in the direction of the arrow SL is blocked.

In this case, the closed space AR is formed between the dust cap 100 for a ferrule and the ferrule 900. As a result, the end surface 910a of the ferrule 900 is to be held in the space and dust or staining can be prevented for a long period of time.

The closed space AR of the dust cap 100 for a ferrule has a space of 1 mm or more in the direction of the arrow SL. Preferably, the space is 3 mm or more and 10 mm or less.

Forming the closed space AR enables the end surface 910a of the ferrule 900 to be prevented from coming into contact with an inner surface of the closing wall 250.

In addition, by forming the closed space AR, even in a state where a green lens or a fixing pin is provided on the end surface 910a of the ferrule 900, protection of the ferrule 900 can be performed by the dust cap 100 for a ferrule.

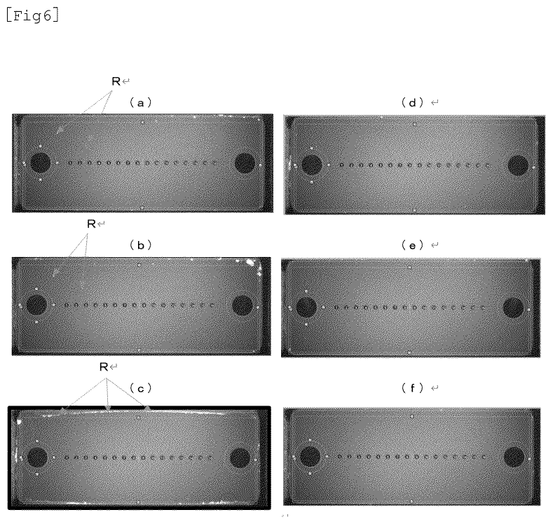

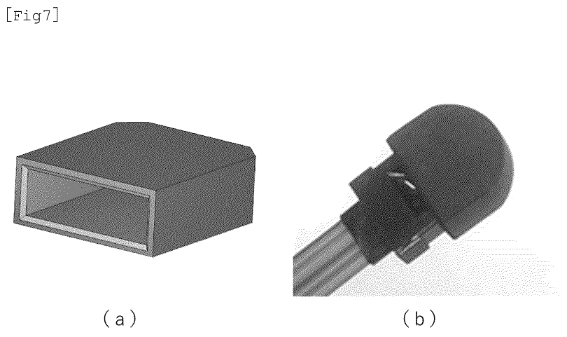

Next, FIG. 6 shows an example of a result of dust or staining using a conventional dust cap for a ferrule and the dust cap 100 for a ferrule according to the present invention. FIG. 7 is an example of a conventional dust cap for a ferrule.

FIGS. 6(a) to 6(c) are a result of a conventional dust cap for a ferrule and FIGS. 6(d) to 6(f) are a result of the dust cap 100 for a ferrule according to the present invention.

First, the end surface 910a of the ferrule 900 was cleaned according to standard IEC TR 62627-01. In addition, the use of the dust cap 100 for a ferrule is recommended for end surface protection.

Next, the ferrule 900 to which the conventional dust cap for a ferrule was mounted and from which the conventional dust cap for a ferrule was removed and the ferrule 900 to which the dust cap 100 for a ferrule according to the present invention was mounted and from which the dust cap 100 for a ferrule according to the present invention was removed were observed using an automatic inspection apparatus that makes determinations according to standard IEC 61300-3-35.

Specifically, images were captured with a CCD camera and a presence or absence of adherence of foreign objects was checked using embedded software that determines foreign objects.

In FIGS. 6(a) to 6(c), foreign objects R were observed on the end surface 910a of the ferrule 900. In addition, as shown in FIG. 6(c), an adherence of streaky staining was also observed. When inserting the ferrule 900 into the conventional dust cap for a ferrule, since the connecting end surface of the ferrule 900 comes into contact with the opening of the dust cap, the foreign objects R adhere to the connecting end surface of the ferrule 900.

On the other hand, adherence of staining was not observed on the end surface 910a of the ferrule 900 using the dust cap 100 for a ferrule according to the present invention.

In the present invention, the ferrule 900 corresponds to the “ferrule”, the dust cap 100 for a ferrule corresponds to the “dust cap for a ferrule”, the closed space AR corresponds to the “closed space, space with a rectangular parallelepiped shape”, the cap section 200 corresponds to the “cap section”, the guide rail section 300 corresponds to the “guide rail section”, the direction of the arrow SL corresponds to the “direction of guidance”, the direction of the arrow DN corresponds to the “different direction”, the tip portion 910 of the ferrule 900 corresponds to the “tip portion”, the flange portion 920 of the ferrule 900 corresponds to the “flange portion”, one of or a plurality of the end surface of the bottom surface 240, the end surface of the left-side wall 220, and the end surface of the right-side wall 230 corresponds to the “blocking section”, the bottom surface 240 corresponds to the “bottom surface”, the left-side wall 220 and the right-side wall 230 of the guide rail section 300 corresponds to the “pair of ribs”, the left-side wall 220 and the right-side wall 230 of the cap section 200 corresponds to the “walls”, the top surface 210 corresponds to the “top surface”, the closing wall 250 corresponds to the “closing wall”, and the ferrule 900 mounted with the dust cap 100 for a ferrule in FIG. 5 corresponds to the “optical connector”.

While a preferable embodiment of the present invention is as described above, the present invention is not limited thereto. It should be understood that various embodiments may be made without deviating from the spirit and the scope of the present invention. Furthermore, operations and effects due to the configuration of the present invention have been described in the present embodiment, the operations and effects are merely examples and are not intended to limit the present invention.

### REFERENCE SIGNS LIST

100 dust cap for a ferrule
200 cap section
210 top surface
220 left-side wall
230 right-side wall
240 bottom surface
250 closing wall
300 guide rail section
900 ferrule
910 tip portion
920 flange portion
AR closed space

1. A dust cap for a ferrule for protecting a tip portion of the ferrule, the dust cap comprising:
a cap section holding the tip portion of the ferrule and forming a closed space; and
a guide rail section guiding the ferrule to the cap section, wherein
the guide rail section has a shape that guides the tip portion of the ferrule from a direction different from a direction in which the ferrule is guided to the cap section.

2. The dust cap for a ferrule according to claim 1, wherein the guide rail section includes a blocking section which blocks guidance of a flange portion of the ferrule to the cap section.

3. The dust cap for a ferrule according to claim 2, wherein the closed space of the cap section forms a space with a rectangular parallelepiped shape in a state where the flange portion is being blocked by the blocking section.

4. The dust cap for a ferrule according to claim 1, wherein
the guide rail section includes a bottom surface and a pair of ribs which correspond to the tip portion of the ferrule and which block the flange portion of the ferrule, and
the cap section forms the closed space with a bottom surface provided so as to be communicated from the bottom surface, walls provided so as to be communicated from the pair of ribs, a top surface which opposes the bottom surface and which is capable of housing the ferrule, and a closing wall which closes the direction of guidance.

5. An optical connector in which the dust cap for a ferrule according to claim 1 is mounted to the ferrule.
